(19) United States
(12) Patent Application Publication
(10) Pub. No.: US 2023/0037653 A1
(43) Pub. Date: Feb. 9, 2023

(54) DELAY SWITCH MODULE

(71) Applicant: EFFIE CO., LTD., Yongin-si, Gyeonggi-do (KR)

(72) Inventor: Gowansoo KO, Suwon-si (KR)

(73) Assignee: EFFIE CO., LTD., Yongin-si, Gyeonggi-do (KR)

(21) Appl. No.: 17/789,747

(22) PCT Filed: Jul. 8, 2021
(86) PCT No.: PCT/KR2021/008687

§ 371 Date: Jun. 28, 2022

(30) Foreign Application Priority Data
Jul. 10, 2020 (KR) 10-2020-0085188

(51) Int. Cl. H01H 43/02; H01H 9/54; F21V 23/04

(52) U.S. Cl. CPC H01H 43/02; H01H 9/54; F21V 23/04

(57) ABSTRACT

The present invention relates to a delay switch module comprising: a delay switch (110), which is connected in parallel to a load switch (SW), is switched on during a set delay-off-time from when the load switch (SW) is switched off, and is switched off when the delay-off-time has elapsed, so that an operation stops when the delay-off-time has elapsed after the load switch (SW) is switched off; and a control unit (120) for sensing on/off switching of the load switch (SW) if there is an on/off switching operation of the load switch (SW) after the load switch (SW) is switched off, and controlling an operation-off of the delay switch (110) so that the set delay-off-time of the delay switch (110) changes according to the on/off switching operation of the load switch (SW).

### TECHNICAL FIELD

The present invention relates to a delay switch module, and more particularly, to a delay switch module suitable for changing a delay time immediately and conveniently without interruption of energy supply.

### BACKGROUND ART

In general, lighting lamps and ventilation fans are installed inside houses or buildings. In particular, for the purpose of ventilation and removal of odors, ventilation fans are essentially installed in toilets, bathrooms, kitchens and cooking rooms.

Such a fan may be operated in association with a switch for a lighting lamp, or may be installed to be operated by a switch for the fan, which is provided separately from a switch for the lighting lamp.

A typical switch for on-off control of the operation of such a lighting lamp or fan is configured to be turned on and off immediately after a switching operation.

On the other hand, recently, in the case of lighting lamps and (ventilation) fans, there have been developed a delay-off lighting lamp or a fan with operation time-delay function, wherein the lighting lamp is turned off or the operation of the fan is stopped with a predetermined time delay after the operation switch is turned off.

That is, in the case of a lighting lamp, this is designed to be turned off after switching off a lighting switch followed by passing a predetermined period of time (delay time). Further, a fan is also designed such that the operation thereof is stopped after a predetermined period of time (delay-off time) required for ventilation.

Further, in the case of a fan having an operation time-delay function in the prior art, when the fan is firstly installed, a dip switch is provided inside a switch device equipped with an operation switch, and a delay-off time is set by operating the dip switch.

Thereafter, in order to change the initially set delay-off time, a process of changing the delay-off time may be performed by operating the dip switch built into the switch device.

However, the process of changing the delay-off time, which was initially set, by operating the dip switch built into the switch device was very inconvenient and difficult for a general user to conduct.

In particular, the delay-off time, which is an operation delay time of the fan, needs to be frequently altered according to the use environment, however, there is a problem in that it is practically very difficult to change the delay-off time immediately and simply whenever a change is required.

### DISCLOSURE

### Technical Problem

The present invention was created to solve the problems of the prior art as described above, and an object of the present invention is to provide a delay switch module with advantages in that:

first, it allows a user to arbitrarily change a set delay-off time into a desired delay time according to the use environment, wherein the delay-off time can be changed only by “clicking” a load switch connected to an electric device to switch on/off, thereby improving use environment for the user (“user environment”) and increasing use satisfaction of the user (“user satisfaction”);

second, it allows the delay-off time to be changed only by a switching operation of the load switch connected to the electric device so that, when there is a request for a change of the delay-off time, the delay-off time can be immediately changed (that is, immediate time change is achieved) and, regardless of age or gender, anyone and even non-experts can easily, conveniently and rapidly change the delay-off time;

third, the delay switch module can be installed without replacing the pre-installed load switch so that installation workability is simple and convenient and, therefore, can be installed by anyone and even non-professional engineers; and

fourth, it is possible to provide the delay switch module suitable for changing the delay time without interruption of energy supply, simultaneously.

### Technical Solution

The delay switch module of the present invention for achieving the above objects may include: a delay switch, which is connected in parallel to a load switch that is accessed between a commercial alternating current (AC) power source and an electric device and turns the electrical device on/off, is switched on for a delay-off time set from when the load switch is switched off, while being switched off when the delay-off time has elapsed, so that the operation of the electric device is automatically stopped when the delay-off time has elapsed after switching off the load switch; and a control unit, which senses on-off switching of the load switch if there is an on-off switching operation of the load switch after switching off the load switch, and controls the operation-off of the delay switch so that the set delay-off time of the delay switch is changed according to the on-off switching operation of the load switch.

The delay switch module according to the present invention is characterized in that the electric device is a ventilation fan (“fan”).

The delay switch module according to the present invention is characterized in that the electric device is a lighting lamp.

### Advantageous Effects

The delay switch module according to the present invention with the above configurations has the following effects in that:

first, it allows a user to arbitrarily change a set delay-off time into a desired delay time according to the use environment, wherein the delay-off time can be changed only by “clicking” a load switch connected to an electric device to switch on/off, thereby improving the user environment and increasing the user satisfaction;

second, it allows the delay-off time to be changed only by a switching operation of the load switch connected to the electric device so that, when there is a request for a change of the delay-off time, the delay-off time can be immediately changed and, regardless of age or gender, anyone and even non-experts can easily, conveniently and rapidly change the delay-off time;

third, the delay switch module can be installed without replacing the pre-installed load switch so that installation workability is simple and convenient and, therefore, can be installed by anyone and even non-professional engineers; and

fourth, it is possible to provide the delay switch module suitable for changing the delay time without interruption of energy supply, simultaneously.

### DESCRIPTION OF DRAWINGS

FIG. 1 is a block diagram of the delay switch module according to an embodiment of the present invention.

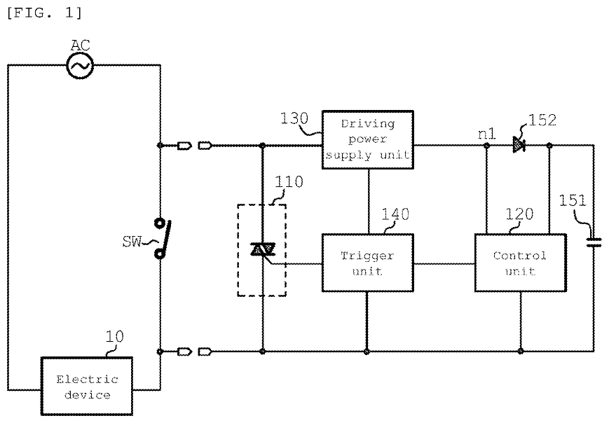

FIG. 2 is an exemplary circuit block diagram of the driving power supply unit 130 in FIG. 1.

FIG. 3 is a waveform conceptual diagram illustrating energy supply in a phase control manner with regard to the driving power supply unit 130 in FIG. 1.

### DETAILED DESCRIPTION OF PREFERRED EMBODIMENTS OF INVENTION

Hereinafter, a preferred embodiment of the delay switch module according to the present invention will be describe in detail with reference to the accompanying drawings.

The electric device described in the present specification refers to any device that operates while receiving electricity (electric power) as a concept including all electronic devices, power devices, and electrical devices.

Preferably, the electric device to be controlled by the present invention is composed of a ventilation fan and, in this case, the delay switch module of the present invention may be a delay switch module for the ventilation fan.

Preferably, the electric device to be controlled by the present invention is composed of a lighting lamp and, in this case, the delay switch module of the present invention may be a delay switch module for the lighting lamp.

The delay switch module according to an embodiment of the present invention is characterized in that it is configured to include a delay switch 110 and a control unit 120.

The delay switch 110 may be a device, which: is connected in parallel to a load switch SW that is connected in series to one among two power lines to supply power from a commercial AC power supply source to the electric device 10 and turns the electric device 10 on/off; and is switched on for a delay-off time (delay operation time) set from when the load switch SW is switched off after operation of the electric device 10, while being switched off when the delay-off time has elapsed, so that the operation of the electric device 10 is automatically stopped (if the electric device is a lamp, it is turned off) when the delay-off time has elapsed after switching off the load switch SW.

Further, the control unit 120 may be a device, which senses on-off switching of the load switch SW if there is an on-off switching operation of the load switch SW after switching off the load switch SW, and controls the operation-off of the delay switch 110 so that the set delay-off time of the delay switch 110 is changed according to the on-off switching operation of the load switch SW.

Due to this, the user may arbitrarily change the preset delay-off time into a desired delay time according to the user environment or necessity. In particular, the on-off operation of the load switch SW is very simple and, if necessary, the delay-off time may be changed immediately, conveniently and rapidly.

Further, the change of the set delay-off time may include extension (5 minutes+3 minutes) of the corresponding time (e.g., 5 minutes) of the set delay-off time or shortening (5 minutes-3 minutes) of the corresponding time (e.g., 5 minutes) of the delay-off time.

Further, since the delay switch module is able to be installed in parallel to the load switch SW that is connected in series to one of AC power lines of the commercial AC power source (AC), the delay switch module may be installed without replacing the previously installed load switch SW. Therefore, installation workability is simple and convenient whereby anyone and even non-professional technician can install the delay switch module.

The control unit 120 detects a change value at both ends of the load switch SW to thus sense switching on-off of the load switch SW, wherein the change value may include, for example, a voltage value, an off duty, etc.

Specifically, for example, when the load switch SW is switched on/off in a very short time after switching off the load switch SW, the control unit 120 may detect a change in voltage value due to the switching-on of the load switch in a very short moment.

As will be described later, according to an embodiment wherein a trigger unit 140 is further provided, the control unit 120 may control the operation of the delay switch 110 through the trigger unit 140.

The load switch SW may be a wall-mounted load switch SW that is embedded in or attached to a wall.

The delay switch 110 may be composed of, for example, a switch element such as a relay, a triac or a field effect transistor (FET).

Further, the control unit 120 is characterized by changing the set delay-off time according to the number of operations of the switching on-off in order to control the operation-off of the delay switch 110.

For example, if the number of switching on-off is 1, the initially set delay-off time of 5 minutes is extended by +3 minutes. Further, if the number of switching on-off is 2, the initially set delay-off time of 5 minutes is extended by +3 minutes*2=6 minutes.

Therefore, it is possible to easily and conveniently set and change a time amount of the delay-off time by a simple operation.

Further, the control unit 120 may control the operation-off of the delay switch 110 by adding a delay time equal to the set delay-off time after the set delay-off time has elapsed according to the number of operations of the switching on-off.

Further, the delay switch module according to an embodiment of the present invention is connected to a rear end of the delay switch 110 and may further include a driving power supply unit 130 to supply the driving power for the control unit 120.

The driving power supply unit 130 may be implemented in various circuit configurations according to embodiments thereof.

The driving power supply unit 130 according to one embodiment is characterized in that, in order to supply the driving power to the control unit 120 when the load switch SW is switched off and while switching on the delay switch 110, a total voltage supplied from the commercial AC power source (AC) to the electric device 10 is partially divided and the divided voltage is applied to the control unit 120 as the driving power.

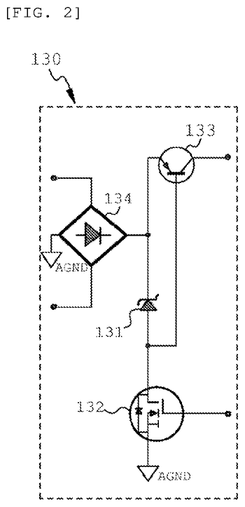

For example, as shown in FIG. 2, the driving power supply unit 130 is characterized in that, in order to supply the driving power to the control unit 120 when the load switch SW is switched off and while switching on the delay switch 110, it is configured to include a voltage divider 131 which partially divides a total voltage supplied from the commercial AC power source (AC) to the electric device 10.

Therefore, the control unit 120 may receive the driving power from the commercial AC power source (AC) during the switching-off time of the load switch SW and, on the other hand, may be operated by receiving the power supplied on the basis of the voltage dropped by the voltage divider 131 as a power required during the switching-on time of the load switch SW.

As described above, by adopting a voltage distribution method such that, when the load switch SW is switched off and while the delay switch 110 is switched on, only a part of the power supplied from the commercial AC power source (AC) to the electric device 10 is supplied to the control unit 120, it is possible to minimize a decrease in power factor of the electric device 10 and to achieve advantages of implementing a very stable operation of the switch without interrupting the power supply to the electric device 10.

Further, when there is a voltage drop in divisional voltage (e.g. 5V) in the voltage divider 131, a voltage resulting from subtracting the divisional voltage (e.g. 5V) from the total voltage (e.g. 220V) (that is, 220-5=215V in the above case) may be supplied to the electric device 10.

Further, according to some embodiments, the driving power supply unit 130 may be configured to further include a condenser (or capacitor) 151, which is connected in parallel to the voltage divider 131 and is charged by the divisional voltage applied to the voltage divider 131, so as to supply the charged power to the control unit 120.

The driving power supply unit 130 may be configured to further include a voltage dividing switch 132, which is connected in parallel to the rear end of the voltage divider 131 and switched on/off according to a control signal of the control unit 120, enabling intermittent current flow to the voltage divider 131.

According to the adoption of the voltage dividing switch 132, the current flowing to the voltage divider 131 may intermittently flow and, even when the load switch SW is switched off through the off operation, the current may flow to the electric device 10 by the voltage divider 131, thereby interrupting the operation of the electric device 10.

Further, the driving power supply unit 130 may be configured to further include a rectifier 134, which is provided at the front end of the control unit 120 as well as the voltage divider 131, so as to rectify alternating current of the commercial AC power source (AC) into direct current. Herein, the rectifier 134 may consist of, for example, a bridge diode.

The driving power supply unit 130 may be configured to further include a bypass switch 133 that is switched on to allow the current to be supplied to the capacitor 151 by the divisional voltage when the load switch SW is switched off while the voltage dividing switch 132 is switched on to flow the current to the voltage divider 131.

Further, when the load switch SW is switched off and the voltage dividing switch 132 is also turned off so that no current flows to the voltage divider 131, the bypass switch 133 may be switched off to thus block the power of the commercial AC power source (AC) from being supplied to the capacitor 151. Therefore, the bypass switch 133 may always be switched on/off in conjunction with the voltage dividing switch 132.

The bypass switch 133 may be automatically switched on/off in conjunction with the on-off of the voltage dividing switch 132, or may be switched under control of the control unit 120.

Further, the voltage divider 131 may be configured of a Zener diode that outputs constant voltage. In this case, regardless of types of the electric device 10, constant voltage may be output to thus supply a stable divisional voltage.

Other than the Zener diode, according to some embodiments, the voltage divider 131 may be configured of a series connection of a plurality of rectifying diodes, resistant elements, or the like. In either case, it is within the technical scope of the present invention.

The voltage dividing switch 132 may be configured of, for example, a field effect transistor (FET).

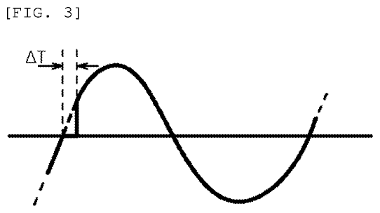

Meanwhile, the driving power supply unit 130 according to another embodiment may supply energy by a phase control method as shown in the conceptual diagram of FIG. 3. In this regard, the phase control method is characterized in that, in order to supply the driving power to the control unit 120 when the load switch SW is switched off and while switching on the delay switch 110, the energy of a part (AT) of the energy cycle supplied from the commercial AC power source (AC) to the electric device 10 is supplied to the control unit 120 as the driving power.

Further, the delay switch module according to an embodiment of the present invention may be configured to further include the capacitor 151, which is charged by receiving the power from the driving power supply unit 150 and then supplies the driving power (energy) to the control unit 120 with the charged voltage.

With regard to the switching on/off operation of the load switch SW, energy supply to the control unit 120 is interrupted at the switching-on time, therefore, the capacitor 151 may supply the driving power to the control unit 120 to drive the same thereby keeping the control unit 120 to continuously work.

As such, after charging the capacitor 151 by, for example, the divisional voltage according to voltage division (or, in the case of the phase control method, the load switch SW is turned off for ΔT time and then, after supplying energy during the above OFF time to charge the capacitor), the driving power may be supplied to the control unit 120 by the voltage charged in the capacitor 151 whereby the driving power can be supplied more stably to the control unit 120 even in a state in which power is supplied to the electric device 10.

The delay switch module according to an embodiment of the present invention may be configured to further include a diode 152, which is connected to the front end of the capacitor 151 and blocks reverse flow of the current charged in the capacitor 151, so as to prevent voltage sensing malfunction of the control unit 120.

Further, the delay switch module according to an embodiment of the present invention may configured to further include a voltage drop unit (not shown) for decreasing the voltage, which is connected between the load switch SW and the control unit 120, more specifically, between the front end of the diode 152 and the control unit 120, so as to enable the control unit 120 more smoothly sense the on-off switching operation of the load switch SW.

The voltage drop unit may consist of, for example, a resistance element.

When the operating voltage of the control unit 120 is 5V, for example, if the voltage value of a node n1 at the front end of the diode 152 is 10V, this 10V exceeds a sensing range of the control unit 120. Therefore, if a voltage drop unit for decreasing voltage is additionally provided between the control unit 120 and the node n1, the switching on-off operation can be sensed by the control unit 120 even when the voltage value at both ends of the load switch SW is high. Preferably, the control unit 120 may sense the switching operation of the load switch SW by detecting a change value at the front end n1 of the diode 152.

The delay switch module according to an embodiment of the present invention may be configured by further include a trigger unit 140, which is connected to the driving power supply unit 130 to output trigger current for switching-on operation of the delay switch 110, even if a control signal is not received from the control unit 120, when the load switch SW is turned off and a current is input from the driving power supply unit 130, thereby operating the delay switch 110.

Further, the trigger unit 140 may switch off the delay switch 110 by blocking the output of the trigger current when the switching-off control signal is received from the control unit 120 after the delay-off time has elapsed.

As described above, by adopting the trigger unit 140, the delay switch 110 may be switched on immediately while switching off the load switch SW, simultaneously, so that the electric device 10 can continuously work without temporary stop. This may solve a disadvantage in that driving the control unit 120 takes time to instantly or temporarily stop the driving of the electric device 10, which may occur in the case of operation control of the delay switch 110 by the control unit 120 without adopting the trigger unit 140.

In the case where the trigger unit 140 is not adopted, when the load switch SW is switched off, the control unit 120 directly outputs a trigger signal to the delay switch 110, thereby switching on the delay switch 110.

As described above, preferred embodiments according to the present invention have been reviewed, and it would be self-evident to persons who have ordinary knowledge in the technical field, to which the present invention pertains (“those skilled in the art”), that the present invention can be implemented in other specific forms without changing the technical spirit or essential features in addition to the above-described embodiments. Therefore, it should be understood that the above-described embodiments are illustrative and not restrictive.

The scope or the present invention is indicated by the appended claims below rather than the above detailed description, and all changes or modifications derived from the meaning and scope of the claims and their equivalents should be construed as being included in the scope of the present invention.

1. A delay switch module, comprising:
a delay switch, which is connected in parallel to a load switch (SW) that is accessed between a commercial alternating current power source (AC) and an electric device (10) and turns the electrical device (10) on/off, is switched on for a delay-off time set from when the load switch (SW) is switched off, while being switched off when the delay-off time has elapsed, so that the operation of the electric device (10) is automatically stopped when the delay-off time has elapsed after switching off the load switch (SW); and
a control unit (120), which senses on-off switching of the load switch (SW) if there is an on-off switching operation of the load switch (SW) after switching off the load switch (SW), and controls the operation-off of the delay switch (110) so that the set delay-off time of the delay switch (110) is changed according to the on-off switching operation of the load switch (SW).

2. The delay switch module according to claim 1, wherein the control unit (120) controls the operation-off of the delay switch (110) by changing the set delay-off time according to the number of operations of the switching on-off.

3. The delay switch module according to claim 1, wherein the control unit (120) senses the switching on-off of the load switch (SW) by detecting a change value at both ends of the load switch (SW), and
wherein the change value at both ends of the load switch (SW) includes any one of a voltage value or off-duty.

4. The delay switch module according to claim 1, further comprising:
a driving power supply unit (130), which is connected to a rear end of the delay switch (110) so as to supply a driving power to the control unit (120).

5. The delay switch module according to claim 4, further comprising:
a capacitor (151), which is charged by receiving a power from the driving power supply unit (150) and supplies the driving power to the control unit (120) with the charged voltage.

6. The delay switch module according to claim 5, further comprising:
a diode (152), which is connected to a front end of the capacitor (151) and blocks reverse flow of a current charged in the capacitor (151) so as to prevent voltage sensing malfunction of the control unit (120).

7. The delay switch module according to claim 1, further comprising:
a trigger unit (140), which is connected to the driving power supply unit (130) to output trigger current for switching-on operation of the delay switch (110) when the load switch (SW) is turned off and a current is input from the driving power supply unit (130), thereby operating the delay switch (110).

8. The delay switch module according to claim 1, wherein the electric device to be controlled by the present invention comprises a ventilation fan, and
wherein the delay switch module is a delay switch module for the ventilation fan.

9. The delay switch module according to claim 1, wherein the electric device comprises a lighting lamp, and
wherein the delay switch module is a delay switch module for the lighting lamp.
